(19) United States
(12) Patent Application Publication
(10) Pub. No.: US 2014/0089319 A1
(43) Pub. Date: Mar. 27, 2014

(54) ONLINE MEDIA SHARING WITH ACTIVITY BALANCING AND INCENTIVES

(71) Applicant: INTERNATIONAL BUSINESS MACHINES CORPORATION, Armonk, NY (US)

(72) Inventors: Geetika T. Lakshmanan, Winchester, MA (US); Michael Muller, Medford, MA (US); Martin Oberhofer, Bondorf (DE)

(73) Assignee: International Business Machines Corporation, Armonk, NY (US)

(21) Appl. No.: 13/626,933

(22) Filed: Sep. 26, 2012

(51) Int. Cl. G06F 17/30

(52) U.S. Cl. 707/748; 707/E17.005

(57) ABSTRACT

Activity is balanced in a media sharing environment. To balance the activity, a computer determines the uploading activity of a plurality of members of a media sharing environment, as well as the tagging activity of the plurality of members. The computer compares the uploading activity to the tagging activity and determines a scoring coefficient responsive to the comparison. The computer determines a member score for one of the plurality of members based on the scoring coefficient. The computer can subject the member to discipline if the member score violates a low threshold, or to a reward if the member score violates a high threshold. The scoring coefficient can be determined to induce the plurality of members to favor either one of the uploading activity and the tagging activity over the other.

### FIELD OF THE INVENTION

The present invention relates generally to online media sharing, and more particularly to providing an online media sharing service with activity balancing and that provides incentives for participation.

### BACKGROUND

Online media sharing services are well known. For example, online photo sharing services include, for example, Facebook, Picasa, Flickr, and Snapfish. Additional online media sharing services exist for the purpose of sharing forms of media besides photos. For example, media sharing services exist also for the purpose of sharing video clips, movies, audio clips, songs, writings, poems, computer source code snippets, and so on. Online media sharing services are generally practiced for most imaginable forms of media data.

Online media sharing services often include a social networking feature, which tracks and enables connections between their members (including people, businesses, institutions, and other entities). The social networking feature further allows members to efficiently communicate information that is relevant to friends or other connections on the online media sharing service. Frequently, the social networking feature of the online media sharing service is used to regulate access to the shared media. For example, photos are available on platforms such as Facebook based on a requesting member's social proximity to the member who uploaded the photos. This method of regulating access can, in some instances, restrict access to shared media in a way that is not beneficial.

Further, regardless of whether this method of regulating access is used, a given online media sharing service will typically suffer from lacking a suitable infrastructure for rewarding beneficial uploading. For example, Facebook provides an infrastructure for members to reward each other for uploading popular content, by allowing members to “like” particular content. Use of the “like” feature allows popular content to receive wider viewership, resulting in social praise for the original uploader. However, this infrastructure for rewarding uploading is not particularly beneficial, because it relies on social discovery and member impulse. For another example, several online photo sharing services provide an infrastructure for picture tagging, by which members can apply written “tags” to each other's uploaded media, to facilitate search discovery. However, this infrastructure for picture tagging is not particularly beneficial, because it still relies on member impulse.

Further still, regardless of what method of regulating access is used, and regardless of what infrastructure for rewarding beneficial uploading is in place, a given online media sharing service will typically become populated with media that is focused on the personal experience of each uploading member, or that contains biases related to the subjective values of each uploading member. In other words, conventional online media sharing services typically allow or encourage each uploading member to upload media about himself, herself, or itself. Such a population of member-focused media, while beneficial in many contexts, sometimes lacks an ability to be objectively or universally appreciated.

### SUMMARY

Embodiments of the present invention provide for a program product, system, and method to balance activity in a media sharing environment. To balance the activity, a computer determines the uploading activity of a plurality of members of a media sharing environment, as well as the tagging activity of the plurality of members. The computer compares the uploading activity to the tagging activity and determines a scoring coefficient responsive to the comparison. The computer determines a member score for one of the plurality of members based on the scoring coefficient. The computer can subject the member to discipline if the member score violates a low threshold, or to a reward if the member score violates a high threshold. The scoring coefficient can be determined to induce the plurality of members to favor either one of the uploading activity and the tagging activity over the other.

### BRIEF DESCRIPTION OF THE SEVERAL VIEWS OF THE DRAWINGS

FIG. 1 is a functional block diagram of a media sharing environment in accordance with an embodiment of the present invention.

FIG. 2A depicts a line graph illustrating an example of the uploading and tagging rates of members in a media sharing environment in accordance with an embodiment of the present invention.

FIG. 2B depicts a histogram illustrating member scores at a particular time in a media sharing environment in accordance with an embodiment of the present invention.

FIGS. 3A and 3B show flowcharts depicting steps followed by a loading and tagging program, an activity balancing program, a member scoring program, and a member incentive program during the performance of online media sharing in accordance with an embodiment of the present invention.

FIG. 4 is a functional block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

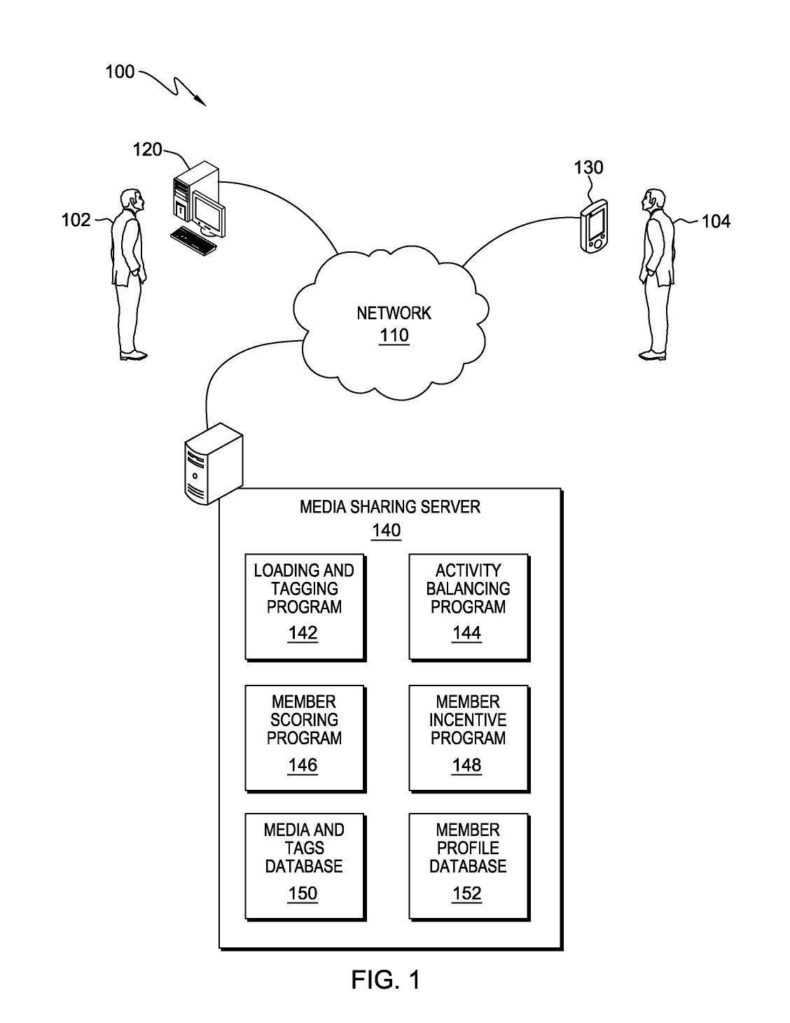

Referring now to FIG. 1, a functional block diagram of media sharing environment 100 in accordance with an embodiment of the present invention is shown. Media sharing environment 100 includes network 110, user device 120, user device 130, and media sharing server 140. Network 110 can be, for example, a local area network (LAN), a wide area network (WAN) such as the Internet, or a combination of the two, and can include wired or wireless connections. In general, network 110 can be any combination of connections and protocols that will support communications via various channels between user device 120, user device 130, and media sharing server 140 in accordance with an embodiment of the invention. Persons 102 and 104 can use media sharing system 100 to share media as discussed below. Media sharing system 100 can be administered by an administrator using an administrative device (not shown). Although the discussion below involves shared media in the form of pictures, it should be understood that the current techniques are not limited to picture sharing, but instead can be practiced with all forms of media including, but not limited to, visual media, audio media, written media, and other forms of media.

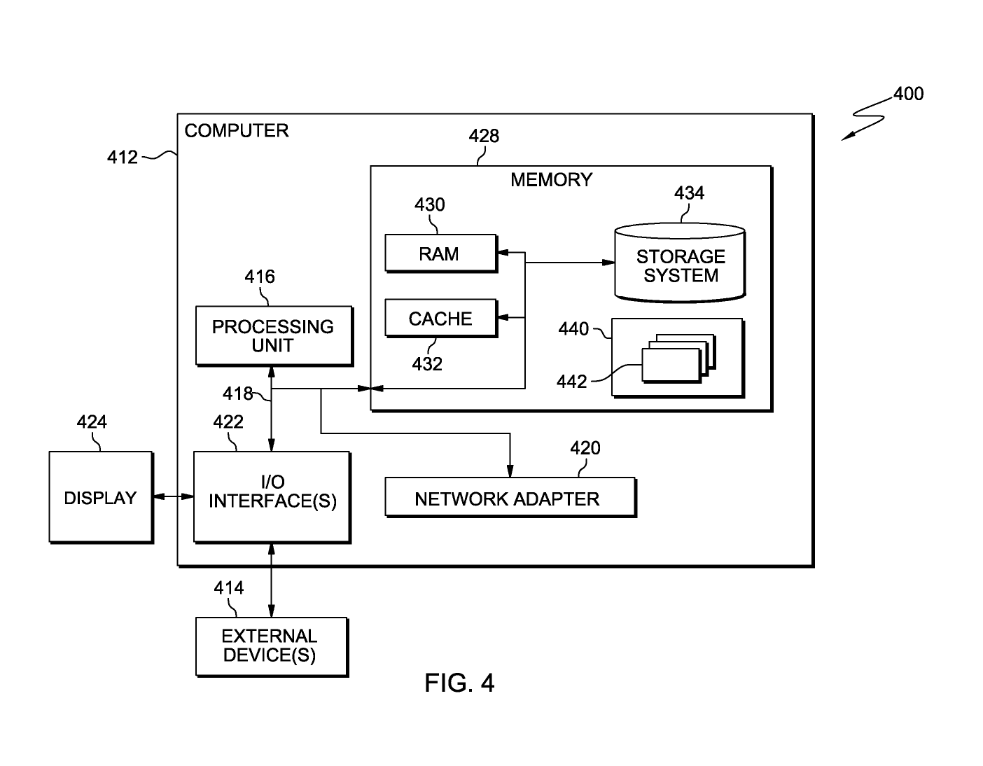

In various embodiments, each one of user device 120, user device 130, and media sharing server 140 can include a laptop, tablet, or netbook personal computer (PC), a desktop computer, a personal digital assistant (PDA), a smart phone, a mainframe computer, or a networked server computer. Further, media sharing server 140 can be computing systems utilizing clustered computers and components to act as single pools of seamless resources when accessed through network 110, or can represent one or more cloud computing datacenters. In general, each one of user device 120, user device 130, and media sharing server 140 can be any programmable electronic device as described in further detail with respect to FIG. 4.

User device 120 and user device 130 each includes a media sharing client program (not shown), which operates as a client of one or more of programs 142, 144, 146, and 148 of media sharing server 140. Each media sharing client program can be implemented as a web browser or a stand-alone client program, and can provide person 102 or person 104 with access to media sharing server 140. With access to media sharing server 140 comes an ability to upload and download pictures and other media to and from media sharing server 140, as well as the ability to manage a member profile, send and receive messages, and perform other operations related to media sharing, as discussed in detail below.

Media sharing server 140 includes loading and tagging program 142, activity balancing program 144, member scoring program 146, member incentive program 148, media and tags database 150, and member profile database 152. Programs 142, 144, 146, and 148 interoperate with each other and utilize data stored in databases 150 and 152 to provide media sharing services to the media sharing client programs of user devices 120 and 130.

Loading and tagging program 142 uploads pictures from media sharing client programs into media and tags database 150, downloads pictures from media and tags database 150 to media sharing client programs, manages tagging information within media sharing environment 100, facilitates searching for media, and performs regulation of the content of media. For example, loading and tagging program 142 can receive a tag from a member and associate it with a particular picture. Each such tag can be a word or phrase that describes a particular picture, or that is otherwise suitable for association with a particular picture. For example, a picture of a mountain might be tagged by members with the words “mountains,” “landscape,” and “climbing.” Members can be prompted to tag media upon upload. In particular, members can be prompted to tag a picture with the name of the event or place captured within the picture. Members may also be prompted to tag a picture with the date and time it was taken. For pictures taken and uploaded contemporaneously, loading and tagging program 142 can automatically perform date and time tagging. Further, pictures can be manually or automatically tagged with their location data. Further still, in one embodiment a predefined tag list that contains terms such as date, location, and event-name exists to help members classify important events by location; for example, a predefined tag list could include “Boston Marathon—April.” In one embodiment, a member who has no media to upload can still utilize loading and tagging program 142 to tag media uploaded by other members. A member with a large number of uploads can upload all of them but only tag several of them, or none of them. Further, a member might purposefully not tag uploaded media right away if at that point in time uploading is incentivized to a greater degree than tagging, as discussed in more detail below.

Loading and tagging program 142 can search media and tags database 150 for pictures matching a particular tag. For example, a search for media associated with a date and time or an event will return media associated with the relevant tags. Further, a search for media associated with the tag “climbing” might return pictures of mountains as well as pictures of ladders. Tags can be associated with multiple pictures, such that pictures are given a set of most common tags based on count, and pictures are clustered by tags. If a tag is associated with multiple pictures, then search results can be sorted based on a tag score for each picture. In one embodiment, if a member is satisfied that a search result picture actually matches the search tag, the member can indicate such satisfaction to loading and tagging program 142, and loading and tagging program 142 can then increase the tag's score with respect to the search result picture. In contrast, if a member is unsatisfied with a search result picture, the member can indicate such dissatisfaction to loading and tagging program 142, and loading and tagging program 142 can then decrease the tag's score with respect to the search result picture. Generally, media and tags database 150 can store media, tags associated with the media, as well as tag scores of the tags associated with the media.

Loading and tagging program 142 can regulate the content of media by, for example, removing personal or inappropriate content, either automatically or upon member flagging. In one embodiment, flagging a picture as inappropriate is a special case of tagging which brings the flagged picture to the attention of administrative review. Loading and tagging program 142 maintains detailed information about the uploading, downloading, tagging, and searching activity of each member in member profile database 152. In one embodiment, uploading, downloading, tagging, and searching can be performed without any restrictions based on a social network or social graph formed amongst the members, such that any member can view or search for any other member's media.

Activity balancing program 144 analyzes the uploading activity and the tagging activity facilitated by loading and tagging program 142, and updates upload and tag scoring coefficients in order to influence such facilitated activity in the future. For example, if activity balancing program 144 determines that uploading activity is exceeding tagging activity, such that a surplus of untagged media is forming in media and tags database 150, then activity balancing program 144 will update the upload and tag scoring coefficients to encourage increased tagging activity. In contrast, if activity balancing program 144 determines that tagging activity is exceeding uploading activity, such that most media in media and tags database 150 is being overtagged, then activity balancing program 144 will update the upload and tag scoring coefficients to encourage increased uploading activity.

Member scoring program 146 utilizes the upload and tag scoring coefficients provided by activity balancing program 144, as well as the activity history of individual members stored in member profile database 152, to score the individual members. Member scores are used for several purposes. For example, low-scoring members can receive disciplinary action, up to and including membership deactivation. In contrast, high-scoring members can receive increased probabilities for receiving rewards for satisfying incentives. Generally, member scoring serves the purpose of increasing the value of member uploads to media sharing server 140.

Member incentive program 148 manages incentives and allocates rewards to members who satisfy incentives. Incentives also serve the purpose of increasing the value of member uploads to media sharing server 140. A variety of incentives can be implemented. For example, geographic incentives can be implemented to encourage members in a particular geographic area to behave in a desirable way. Similarly, demographic incentives, member profile-based incentives, topic incentives, and other incentives can be implemented.

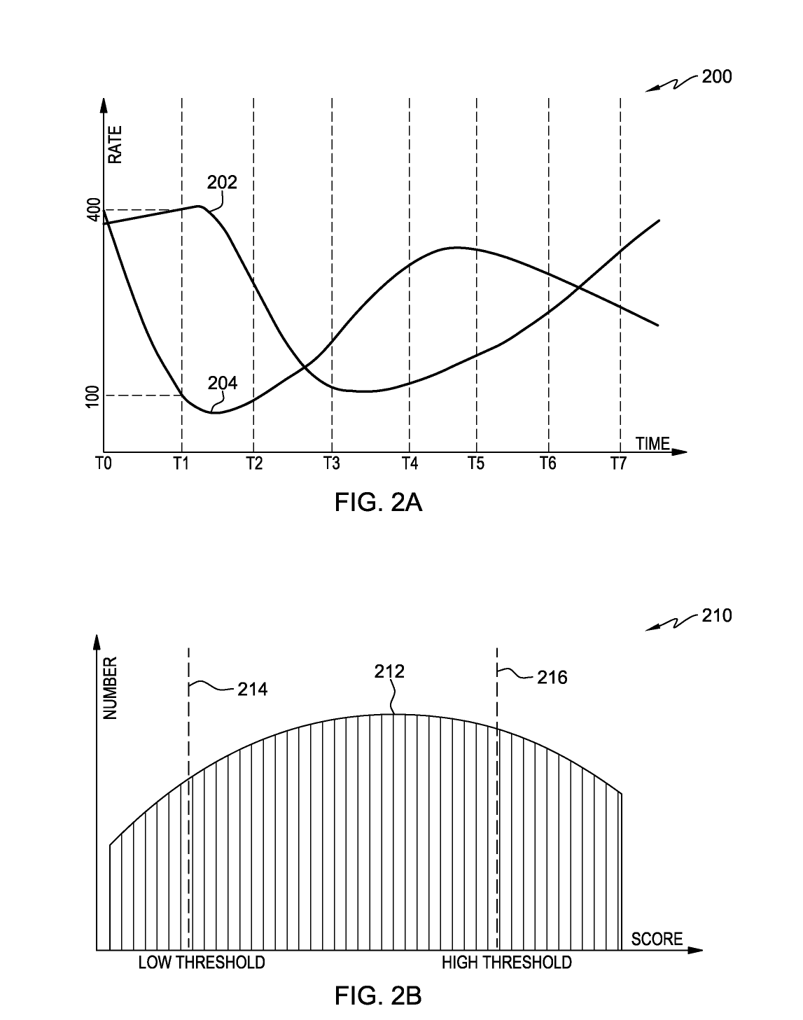

FIG. 2A depicts graph 200, a line graph illustrating an example of the uploading and tagging rates of members in media sharing environment 100. In particular, graph 200 depicts uploading rate 202 and tagging rate 204 as lines that vary over the time period between time T0 and time T7, and that are measured in terms of activities per unit time. In one embodiment, the time period between each interval (e.g., the interval time T0 to time T1, or time T1 to time T2) is ten minutes, and the unit time can be selected as one minute, but in various embodiments the time period and the unit time can be any measure of time. Uploading rate 202 represents the number of pictures or other media being uploaded to media sharing server 140 per minute, and tagging rate 204 represents the number of pictures or other media that are associated with tags per minute. According to variations of the current technique, tagging rate 204 can measure, for example, the rate members are adding tags to previously untagged pictures (e.g., the rate of conversion from untagged to tagged media) or can measure the rate members are adding tags to all pictures (e.g., the rate of tag accumulation across all media, tagged or untagged).

As shown in graph 200, uploading rate 202 increases slightly from below 400 pictures per minute at time T0 to 400 pictures per minute at time T1. Uploading rate 202 then increases slightly after time T1, declines through time T3, and increases again after time T4. In the meanwhile, tagging rate 204 decreases precipitously from nearly 400 tags per minute near time T0 to 100 tags per minute at time T1. Tagging rate 204 then decreases slightly after time T1, increases through time T4, and decreases again after time T5.

Uploading rate 202 and tagging rate 204 are analyzed by activity balancing program 144, which updates upload and tag scoring coefficients with the goal of influencing future member behavior, by inducing the members to favor one activity over the other, for example. This analysis can be performed continuously or periodically. In the depicted embodiment, activity balancing program 144 performs the analysis at the end of each interval (e.g., at time T1, and then at time T2, etc.). To perform the analysis at time T1, for example, activity balancing program 144 first determines the number of untagged pictures stored in media and tags database 150 at the beginning of the interval from time T0 to time T1. For the sake of discussion, it is assumed that there were 500 untagged pictures at time T0. Next, activity balancing program 144 determines the total number of uploads during the interval, by integrating uploading rate 202 over the interval. Because uploading rate 202 is very close to, or equal to, 400 pictures per minute over the interval, for the sake of discussion the total number of uploads will be approximated as 4000 during the entire 10 minutes. Activity balancing program 144 also determines the total number of tags during the preceding interval from time T0 to time T1, by integrating tagging rate 204 over the interval. Tagging rate 204 declines from approximately 400 to 100 tags per minute over the interval, so for the sake of discussion the total number of tags will be approximated at 2500 over the entire 10 minutes. Having performed the above analysis, activity balancing program 144 can then determine that the new amount of untagged pictures at time T1 is 2000 (500 pictures at time T0, plus 4000 new pictures, minus 2500 taggings). In another embodiment, the new amount of untagged pictures at time T1 can be determined by querying media and tags database 150 at time T1.

Having determined the new amount of untagged pictures at time T1, activity balancing program 144 continues updating upload and tag scoring coefficients. In particular, an upload scoring coefficient is set equal to 1 minus the new amount of untagged pictures divided by a scaling factor, provided that the result is constrained to exist in the range of 0 to 1. Therefore, as the new amount of untagged pictures grows, the upload scoring coefficient moves from 1 toward 0. The scaling factor can be selected to equal a number of untagged pictures beyond which all future member activity should be directed away from uploading, but before which only some portion of future member activity should be directed away from uploading. For example, if the scaling factor is 1000, then all future member activity is directed to tagging if there are at least 1000 untagged pictures. For the sake of discussion, the scaling factor is 2500, and thus the upload scoring coefficient is set equal to 0.2 (1 minus the quotient of 2000 new untagged pictures divided by the 2500 scaling factor). Having determined the upload scoring coefficient, activity balancing program 144 sets the tag scoring coefficient to 1 minus the upload scoring coefficient. Generally, the upload and tag scoring coefficients sum to 1.

Having updated the upload and tag scoring coefficients at time T1, activity balancing program 144 provides the upload and tag scoring coefficients to member scoring program 146, which uses them, as well as the activity history of individual members stored in member profile database 152, to score the individual members in the following interval between time T1 and time T2. Each member will receive a member score from member scoring program 146 equal to his or her uploads in the following interval multiplied by the upload scoring coefficient, plus his or her tags in the following interval multiplied by the tag scoring coefficient. In order to avoid unduly penalizing members who are inactive for short periods of time, member scores can be determined on, for example, a rolling average basis over a period of time including multiple intervals.

During the first interval from time T0 to time T1, upload and tag scoring coefficients of 0.2 and 0.8, respectively, were determined. Thus, during the following interval from time T1 to time T2, members will receive scores based on these updated coefficients that favor tagging over uploading. In other words, during the first interval, because uploading rate 202 was significantly higher than tagging rate 204, in the following interval the upload and tag scoring coefficients have been updated to encourage behavior that closes the gap. It can be seen that this is precisely what occurs in the following interval, as users react to the updated coefficients by reducing uploading rate 202 and increasing tagging rate 204, in an effort to improve their scores. To promote such user reaction, the upload and tag scoring coefficients can be displayed to members via their media sharing client programs. Generally, if there are a large number of untagged pictures uploaded, they cannot be effectively searched by the member community and are thus less valuable. On the other hand, if there is no new media uploaded, value is lost for the members as well because there is no new media to generate renewed interest. Thus, it is in the best interest of the member community to have a steady stream of uploaded media which is contemporaneously tagged to facilitate searching.

During the following intervals, activity balancing program 144 continues to perform analysis, and member scoring program 146 continues to perform member scoring, in order to continue balancing member activity in an optimal way. For example, as member tagging activity begins to significantly outstrip member uploading activity during the intervals following time T3, the upload and tag scoring coefficients are updated to close the gap, such that uploading activity eventually surpasses tagging activity after time T6.

FIG. 2B depicts graph 210, a histogram illustrating member scores at a particular time in media sharing environment 100. In particular, graph 210 depicts line 212 that varies over a range of member scores, at time T2. As such, graph 210 can be regarded as a “snapshot” of the entire set of member scores at time T2. Members having scores below low threshold 214 can be subject to discipline, while members having scores above high threshold 216 can be subject to a reward. In one embodiment, a score above high threshold 216 is necessary to establish a member's eligibility for a reward, while in another embodiment a score above high threshold 216 merely increases the member's likelihood of winning the reward. In one embodiment, the bulk of members between both thresholds are not subject to discipline or rewards. Members might have scores below low threshold 214 because, for example, they disregarded the updated coefficients introduced at time T1, and continued performing uploads although the tag scoring coefficient was much higher. Discipline for having a score below low threshold 214 can include member account deactivation, suspension, or deletion. Members might have scores above high threshold 216 because, for example, they closely observe updated coefficients at each interval, and always perform activities that will yield higher scores to them, in order to increase the likelihood of receiving member rewards.

Member rewards can be provided to members who satisfy the conditions of an incentive and who maintain member scores above high threshold 216. Incentives can be established from time to time by administrators of media sharing environment 100 or automatically by member incentive program 148. Member incentive program 148 manages incentives and allocates rewards to members who satisfy incentives. A variety of incentives can be implemented. For example, geographic incentives can be implemented to encourage members in a particular geographic area to behave in a desirable way. In particular, if an interesting news event occurred, such as a snow storm in the month of May in the state of New York, an incentive can be created to reward the upload of the 10 highest-ranked pictures related to the snow storm within 2 days, or to reward the tagging of uploads related to the snow storm. Further, demographic incentives or member profile-based incentives, can be implemented to encourage members conforming to certain demographic categories or member profile categories to behave in a desirable way. For example, demographic incentives or member profile-based incentives based on member age or education levels can be implemented. For example, an incentive encouraging members with post-graduate educational degrees to tag 100 pictures can be created. Further still, topic incentives can be implemented. For example, member incentive program 148 can determine predefined categories for media, such as geography based categories, where each category represents a country, county, metropolitan region, or other region; or time based categories, where each category represents a time period such as a month or a range of years. Further, member incentive program 148 can automatically determine the density of media in each category. For categories with a low media density, the member incentive program 148 can generate an incentive that encourages members to upload pictures to the sparse category for a reward.

In one embodiment, the reward for an incentive is negotiated with advertisers within media sharing environment 100. Members who win an incentive can be recognized and declared publicly within media sharing environment 100, can receive an increased member score, or can receive other rewards. In various embodiments, rewards for the incentive can include a monetary prize, a vacation package, access to a privileged data set or an enhanced media sharing environment feature, or another reward designed to spur member activity. In one embodiment, the reward is provided by an external agency that wants to advertise within media sharing environment 100.

As discussed above, in one embodiment, members having scores below low threshold 214 can be subject to discipline, while members having scores above high threshold 216 can be rewarded. However, in another embodiment, the relationship between thresholds and rewards can be different. For example, members having scores below low threshold 214 or above high threshold 216 can be subject to discipline, while members having scores in the middle range can be rewarded, or can be eligible to be rewarded. In such an embodiment, members might have scores below low threshold 214 because, for example, they disregarded the updated coefficients introduced at time T1, and continued performing uploads although the tag scoring coefficient was much higher. Members might have scores above high threshold 216 because, for example, they are dominating the service to the detriment of moderate-activity members. Such an embodiment can be enhanced by the introduction of additional third and fourth thresholds that specify a range of “optimal” or “target” participation within low threshold 214 and high threshold 216.

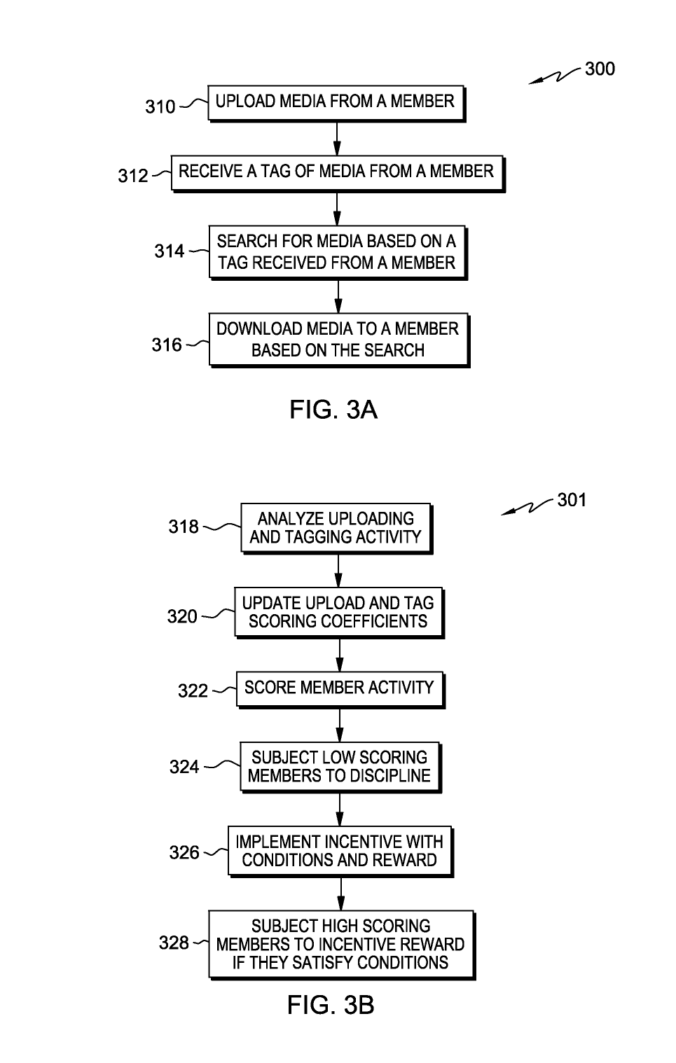

FIGS. 3A and 3B show flowcharts 300 and 301 depicting steps followed by loading and tagging program 142, activity balancing program 144, member scoring program 146, and member incentive program 148 during the performance of online media sharing in accordance with an embodiment of the present invention. Generally, steps followed by programs 142, 144, 146, and 148 can be taken sequentially or in parallel. In step 310, media is uploaded from a member by loading and tagging program 142 of media sharing server 140. For example, loading and tagging program 142 can upload a picture from a media sharing client program of user device 120 into media and tags database 150. In step 312, media is tagged by a member by loading and tagging program 142. For example, loading and tagging program 142 can receive a tag of the uploaded picture from the media sharing client program of user device 120 and associate the tag with the uploaded picture in media and tags database 150. In particular, the picture may have been taken and the tag may have been typed by person 102 utilizing user device 120.

In step 314, loading and tagging program 142 searches for media based on a tag received from a media sharing client program of user device 130. In step 316, loading and tagging program 142 downloads media to the media sharing client program of user device 130 based on the search. For example, person 104 may have typed one or more search tags into user device 130 to be searched by media sharing server 140. Having received the one or more search tags, loading and tagging program 142 can then search for and locate media corresponding to the one or more search tags, and download the resulting media to user device 130. If a search tag equals or is similar to the tag previously submitted by user device 120, then the picture uploaded from user device 120 may be downloaded to user device 130. Loading and tagging program 142 can maintain detailed information about the uploading, downloading, tagging, and searching activity of person 102 and person 104 in member profile database 152.

In step 318, depicted in FIG. 3B, activity balancing program 144 of media sharing server 140 analyzes the uploading and tagging activity of person 102, person 104, and of any other members of media sharing environment 100, to determine whether uploading and tagging activities are balanced, or whether one or the other activity is outstripping the other, such that a surplus of untagged media exists, or such that a dearth of new media exists. In step 320, activity balancing program 144 updates the upload and tag scoring coefficients in response to the analysis. The upload and tag scoring coefficients can be displayed to person 102 and person 104 via the media sharing client programs of user devices 120 and 130, respectively.

In step 322, member scoring program 146 of media sharing server 140 scores the activity of person 102 and person 104 according to the updated upload and tag scoring coefficients. Generally, member scoring program 146 will perform this scoring during a time interval that follows the time interval which provided data for the updating. For example, the scoring will be performed during the interval from time T1 to time T2 shown in FIG. 2A, using data provided from operation during the interval from time T0 to time T1. In step 324, member scoring program 146 subjects low scoring members to discipline, including member account deactivation, suspension, or deletion. For example, low scoring members can be those members scoring below low threshold 214.

In step 326, member incentive program 148 of media sharing server 140 implements incentives with conditions and a reward. For example, incentives can be based upon geography, topics, demographics, member profiles, and other criteria. Rewards can include a monetary prize, a vacation package, access to a privileged data set or an enhanced media sharing environment feature, or another reward designed to spur member activity. In step 328, member incentive program 148 subjects high scoring members to an incentive reward if they satisfy the conditions of a particular incentive. For example, high scoring members can be those members scoring above high threshold 216.

Referring now to FIG. 4, a functional block diagram of a computer system in accordance with an embodiment of the present invention is shown. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove.

In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of user device 120, user device 130, and media sharing server 140 can include or can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 in computer system 400 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program 440, having one or more program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Each one of loading and tagging program 142, activity balancing program 144, member scoring program 146, and member incentive program 148 can be implemented as or can be an instance of program 440.

Computer 412 may also communicate with one or more external devices 414 such as a keyboard, a pointing device, etc., as well as display 424; one or more devices that enable a user to interact with computer 412; and/or any devices (e.g., network card, modem, etc.) that enable computer 412 to communicate with one or more other computing devices. Such communication can occur via Input/Output (I/O) interfaces 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for balancing activity in a media sharing environment, the method comprising the steps of:
a computer determining the uploading activity of a plurality of members of a media sharing environment;
the computer determining the tagging activity of the plurality of members of the media sharing environment;
the computer comparing the uploading activity to the tagging activity;
responsive to the comparison, the computer determining a scoring coefficient; and
the computer determining a member score for one of the plurality of members based on the scoring coefficient.

2. The method of claim 1, further comprising the step of:
the computer subjecting the one of the plurality of members to discipline if the member score violates a low threshold.

3. The method of claim 1, further comprising the step of:
the computer subjecting the one of the plurality of members to a reward if the member score violates a high threshold.

4. The method of claim 1, wherein the determining the scoring coefficient includes determining the scoring coefficient to induce the plurality of members to favor one of the uploading activity and the tagging activity over the other.

5. The method of claim 1, further comprising the step of:
the computer determining whether one or both of the uploading activity and the tagging activity satisfies an incentive.

6. The method of claim 1, wherein the determining the member score includes multiplying a rate associated with one of the uploading activity and the tagging activity by the scoring coefficient.

7. The method of claim 1, further comprising the step of:
determining whether the uploading activity includes uploading media including personal content and, if so, removing the media including personal content.

8. A computer program product for balancing activity in a media sharing environment, the computer program product comprising:
one or more computer-readable tangible storage devices and program instructions stored on at least one of the one or more storage devices, the program instructions comprising:
program instructions to determine the uploading activity of a plurality of members of a media sharing environment;
program instructions to determine the tagging activity of the plurality of members of the media sharing environment;
program instructions to compare the uploading activity to the tagging activity;
program instructions to determine, responsive to the comparison, a scoring coefficient; and
program instructions to determine a member score for one of the plurality of members based on the scoring coefficient.

9. The computer program product of claim 8, further comprising:
program instructions to subject the one of the plurality of members to discipline if the member score violates a low threshold.

10. The computer program product of claim 8, further comprising:
program instructions to subject the one of the plurality of members to a reward if the member score violates a high threshold.

11. The computer program product of claim 8, wherein determining the scoring coefficient includes determining the scoring coefficient to induce the plurality of members to favor one of the uploading activity and the tagging activity over the other.

12. The computer program product of claim 8, further comprising:
program instructions to determine whether one or both of the uploading activity and the tagging activity satisfies an incentive.

13. The computer program product of claim 8, wherein determining the member score includes multiplying a rate associated with one of the uploading activity and the tagging activity by the scoring coefficient.

14. The computer program product of claim 8, further comprising:
program instructions to determine whether the uploading activity includes uploading media including personal content and, if so, removing the media including personal content.

15. A system for balancing activity in a media sharing environment, the system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to determine the uploading activity of a plurality of members of a media sharing environment;
program instructions to determine the tagging activity of the plurality of members of the media sharing environment;
program instructions to compare the uploading activity to the tagging activity;
program instructions to determine, responsive to the comparison, a scoring coefficient; and
program instructions to determine a member score for one of the plurality of members based on the scoring coefficient.

16. The system of claim 15, further comprising:
program instructions to subject the one of the plurality of members to discipline if the member score violates a low threshold.

17. The system of claim 15, further comprising:
program instructions to subject the one of the plurality of members to a reward if the member score violates a high threshold.

18. The system of claim 15, wherein determining the scoring coefficient includes determining the scoring coefficient to induce the plurality of members to favor one of the uploading activity and the tagging activity over the other.

19. The system of claim 15, further comprising:
program instructions to determine whether one or both of the uploading activity and the tagging activity satisfies an incentive.

20. The system of claim 15, wherein determining the member score includes multiplying a rate associated with one of the uploading activity and the tagging activity by the scoring coefficient.
